(19) United States
(12) Patent Application Publication
(10) Pub. No.: US 2011/0141402 A1
(43) Pub. Date: Jun. 16, 2011

(54) LIGHTING DEVICE, DISPLAY DEVICE AND TELEVISION RECEIVER

(75) Inventor: Keiji Hayashi, Osaka-shi (JP)

(73) Assignee: SHARP KABUSHIKI KAISHA, Osaka-shi, Osaka (JP)

(21) Appl. No.: 12/999,318

(22) PCT Filed: Jun. 8, 2009
(86) PCT No.: PCT/JP2009/060433

§ 371 Date: Dec. 16, 2010

(30) Foreign Application Priority Data
Jul. 8, 2008 (JP) 2008-178374

(51) Int. Cl. G02F 1/1335; F21V 7/04

(52) U.S. Cl. 349/65; 362/613

(57) ABSTRACT

A lighting device 12 of the present invention includes a light source 33, a chassis 14 configured to house the light source 33, a heat conductive part 24 that transfers heat generated from the light source 33, and a columnar member 50 that keeps a shape of the chassis 14. The columnar member 50 is configured by a hollow member that is provided on a side of the chassis 14 opposite from a side facing the light source 33, and the hollow member has an openings 52a, 52b that communicate inside with outside of the hollow member. The heat conductive part 24 is provided on a part of the chassis 14 that overlaps with the light source 33 and extends from the part overlapping with the light source 33 to a part of the chassis 14 that overlaps with the columnar member 50.

### TECHNICAL FIELD

The present invention relates to a lighting device, a display device and a television receiver.

### BACKGROUND ART

In recent years, flat display devices using a flat display element such as a liquid crystal panel and a plasma display panel have been used widely in image display devices such as television receivers compared with conventional Braun tubes. This enables an image display device to be thinner.

A liquid crystal panel included in a liquid crystal display device does not emit light, and thus a backlight device is required as a separate lighting device. The backlight device is arranged behind the liquid crystal panel (i.e., on a side opposite from a display surface side). It includes a metal chassis having an opening on a liquid crystal panel side and a light source accommodated in the chassis.

An edge-light type backlight device has been known for making the backlight device thinner. In the edge-light type backlight device, light sources are arranged on peripheral parts of the chassis. Light emitting from the light sources enters light guide plate to convert the light into planer light and the planer light is directed to the liquid crystal panel. In such a thin backlight device, a space in the device is small and closed. This makes difficult to release heat generated from the light sources to outside of the device. Therefore, in such a thin backlight device, the temperature is easy to increase in the surroundings of the light sources and this easily lowers luminance efficiency and causes thermal deterioration of the light sources. To solve such problems, it has been known that a heat conductive part that transfers heat of a heat generation part is provided on an outer surface of the chassis (see Patent Document 1).

[Patent Document 1] Japanese Unexamined Patent Publication No. 2007-248570

### Problem to be Solved by the Invention

In the configuration disclosed in Patent Document 1, if the light sources function as the heat generation part, the heat conductive part improves heat conductivity of the outer surface of the chassis. This moderates a temperature distribution of the backlight device. However, as the number of light sources or the size of each light source increases due to the increase in size of the liquid crystal display device, an amount of heat generated from the light sources increases. Therefore, heat may not be efficiently released by the method disclosed in Patent Document 1.

### DISCLOSURE OF THE PRESENT INVENTION

The present invention was made in view of the foregoing circumstances. An object of the present invention is to provide a display device in which heat is effectively released to ensure a uniform temperature distribution. Another object of the present invention is to provide a display device including such a lighting device and a television receiver including such a display device.

### Means for Solving the Problem

To solve the above problem, a lighting device of the present invention includes at least one light source, a chassis housing the light source, a heat conductive part that transfers heat generated from the light source, and a columnar member that keeps a shape of the chassis. The columnar member is configured by a hollow member that is provided on a side of the chassis opposite from a side facing the light source, and the hollow member has an opening that communicates inside with outside of the hollow member. The heat conductive part is provided on a part of the chassis that overlaps with the light source and extends from the part overlapping with the light source to a part of the chassis that overlaps with the columnar member.

Since the heat conductive part is provided on the part of the chassis that overlaps with the light source, heat generated from the light source is transferred to the heat conductive part and dispersed in the heat conductive part. This suppresses the temperature in the vicinity of the light source from rising. Further, the heat conductive part extends from the part of the chassis that overlaps with the light source to the part of the chassis that overlaps with the columnar member. Therefore, the heat dispersed in the heat conductive part is transferred to the columnar member. The columnar member is formed in the hollow member and has an opening that communicates inside with outside of the hollow member. Therefore, convection of a heat carrier (air) is caused in a hollow part of the columnar member and the heat is released outside via the opening. The columnar member has a function of keeping a shape of the chassis and a function of releasing the heat generated from the light source. As a result, the heat generated from the light source is preferably released via the heat conductive part and the columnar member. This suppresses the temperature of the lighting device from rising and a uniform temperature distribution is ensured. Such a configuration is especially effective in a flat lighting device that is less likely to release heat generated from the light source.

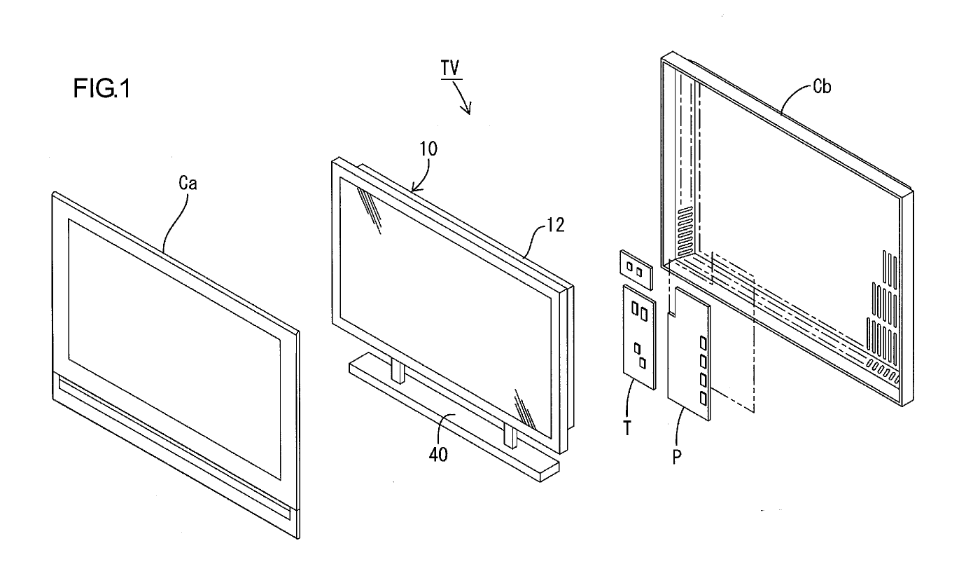

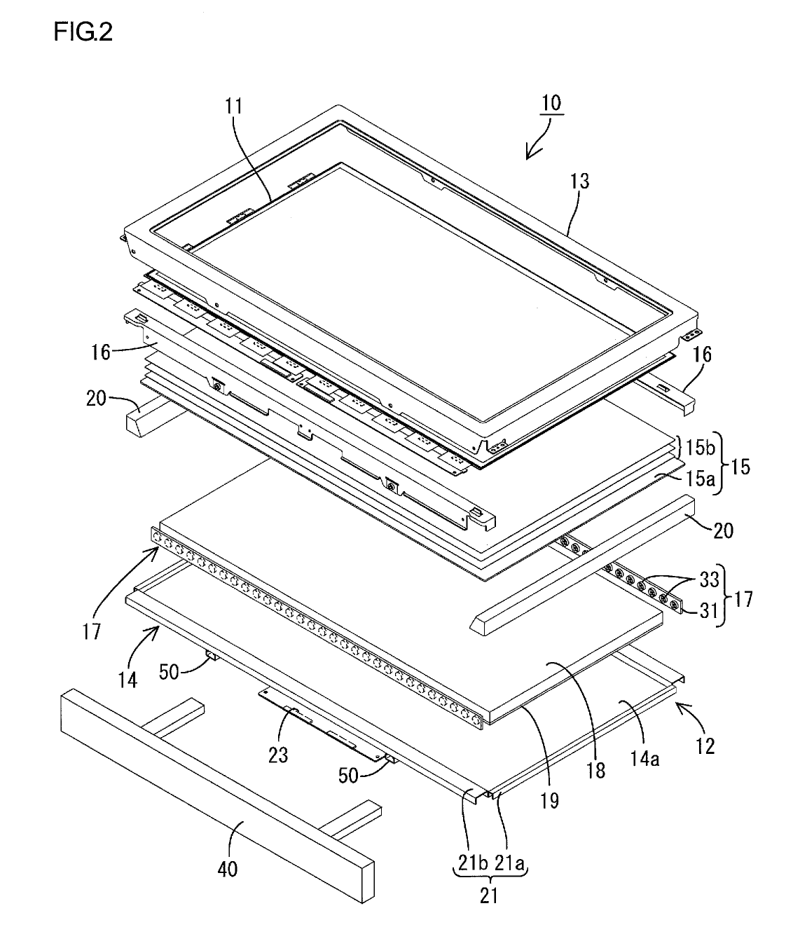

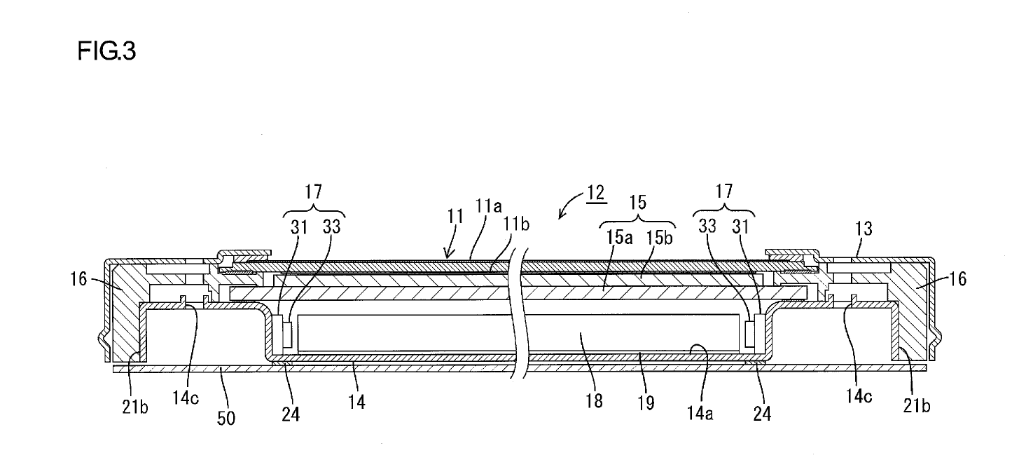

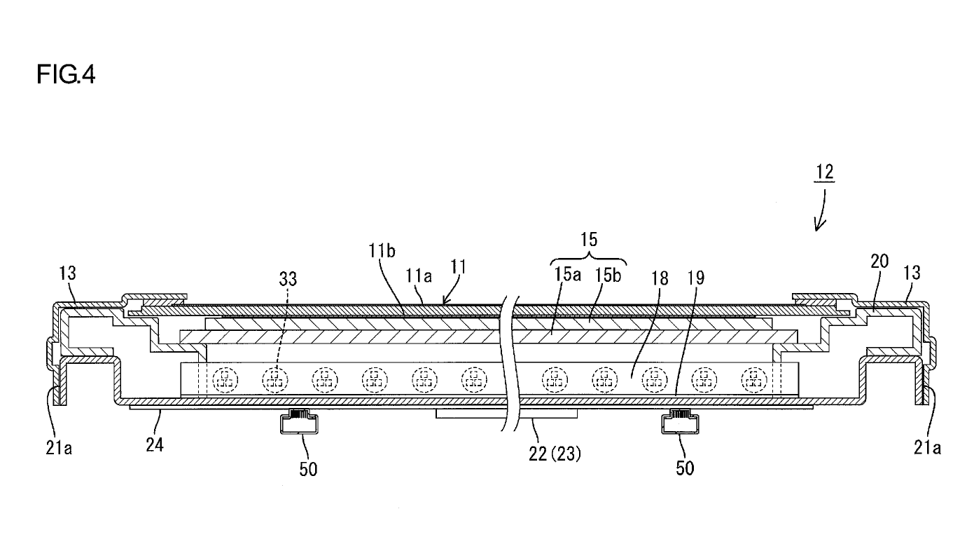

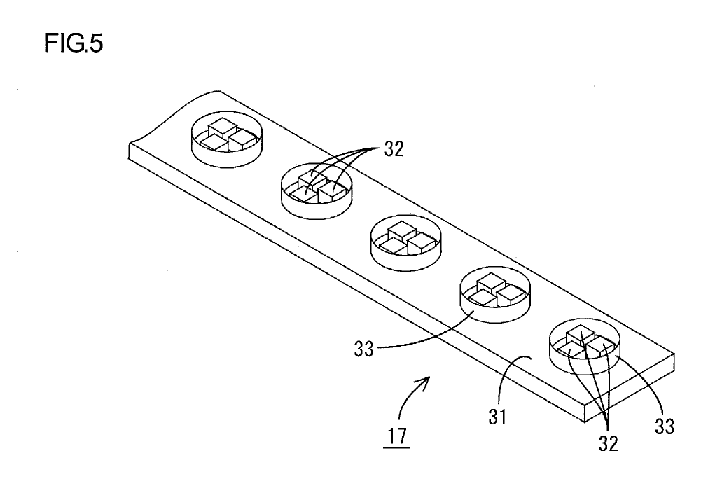

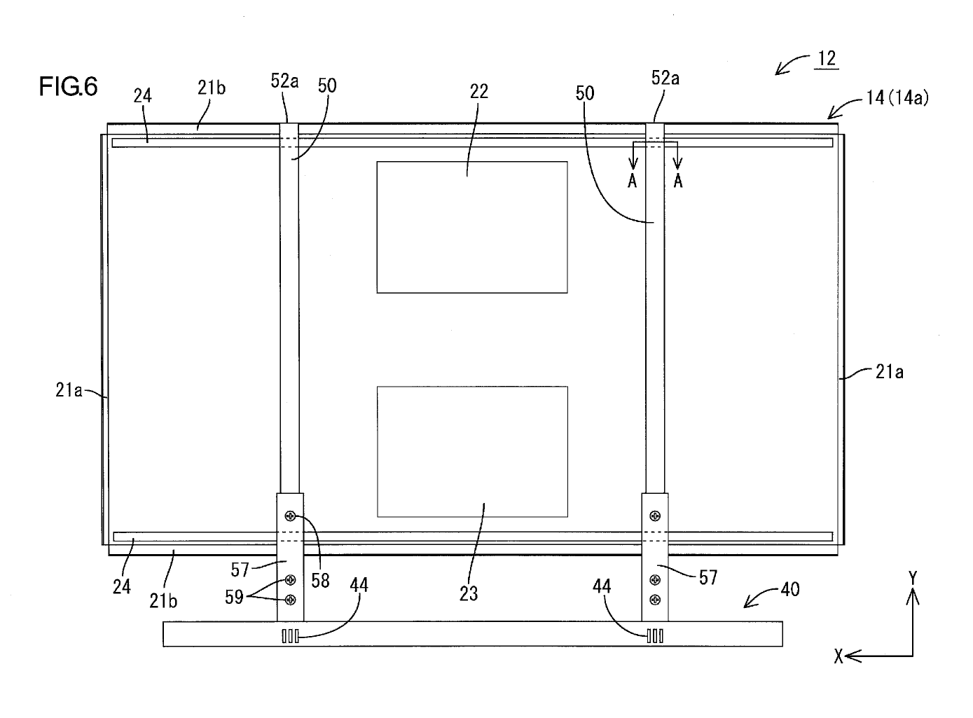

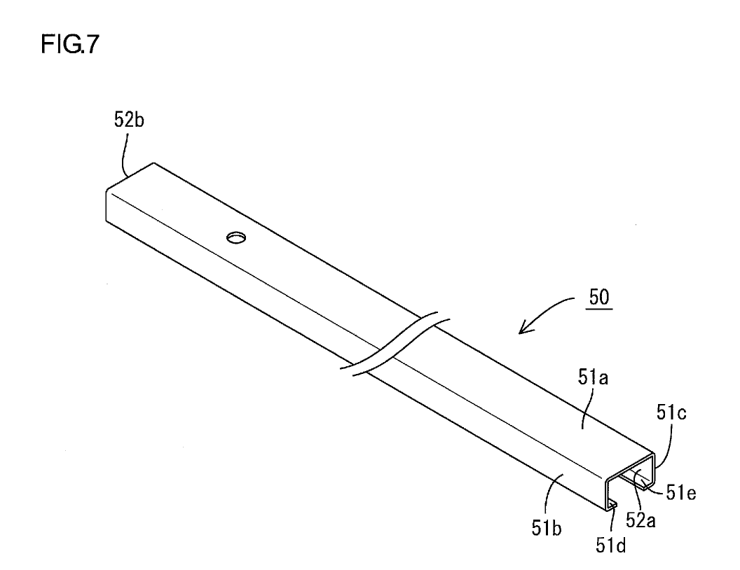

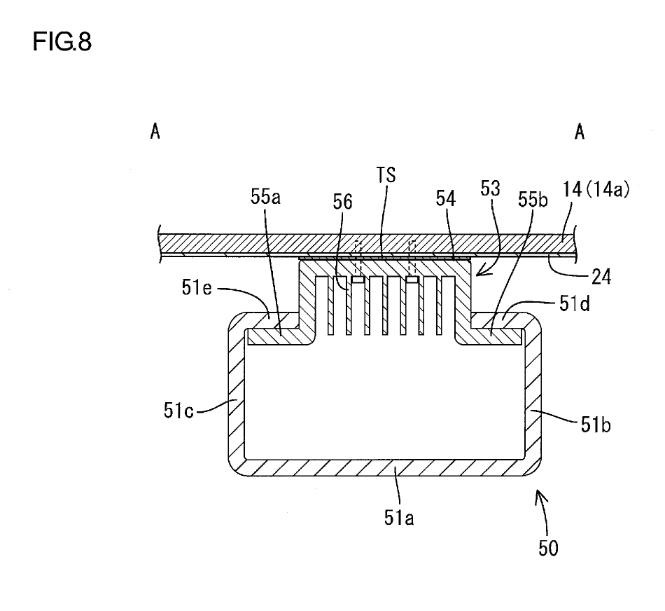

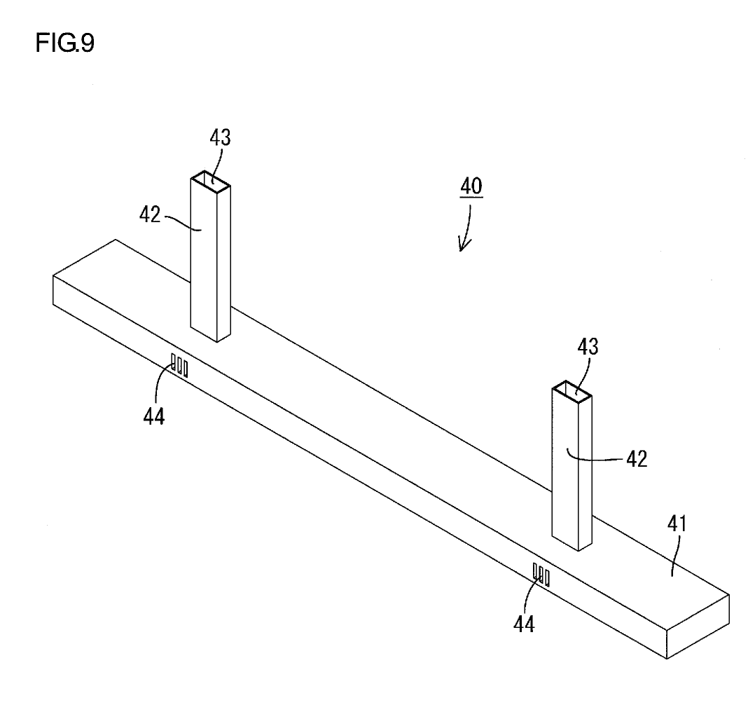

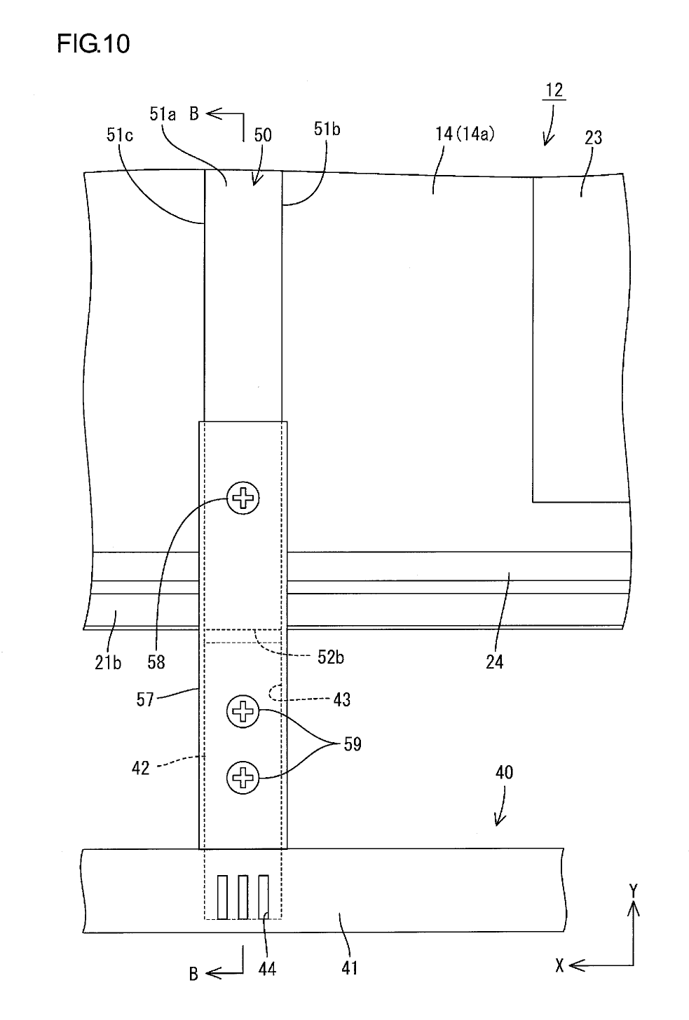

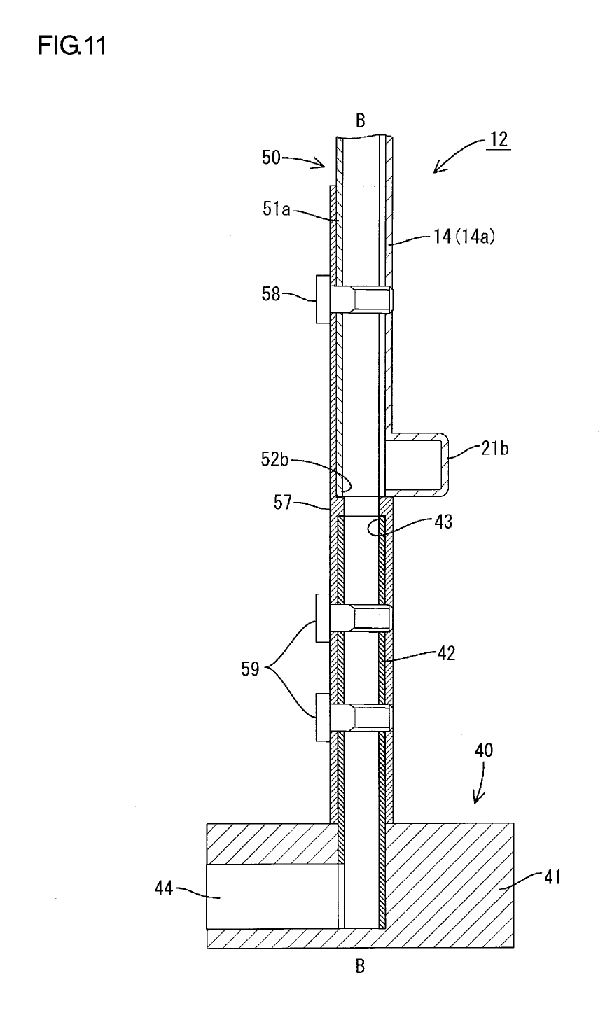

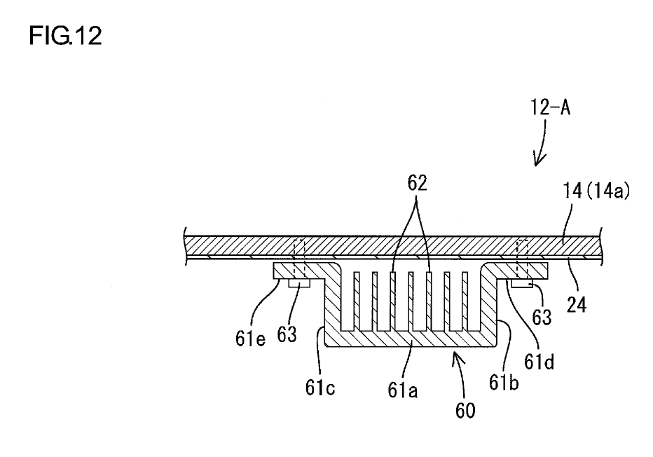

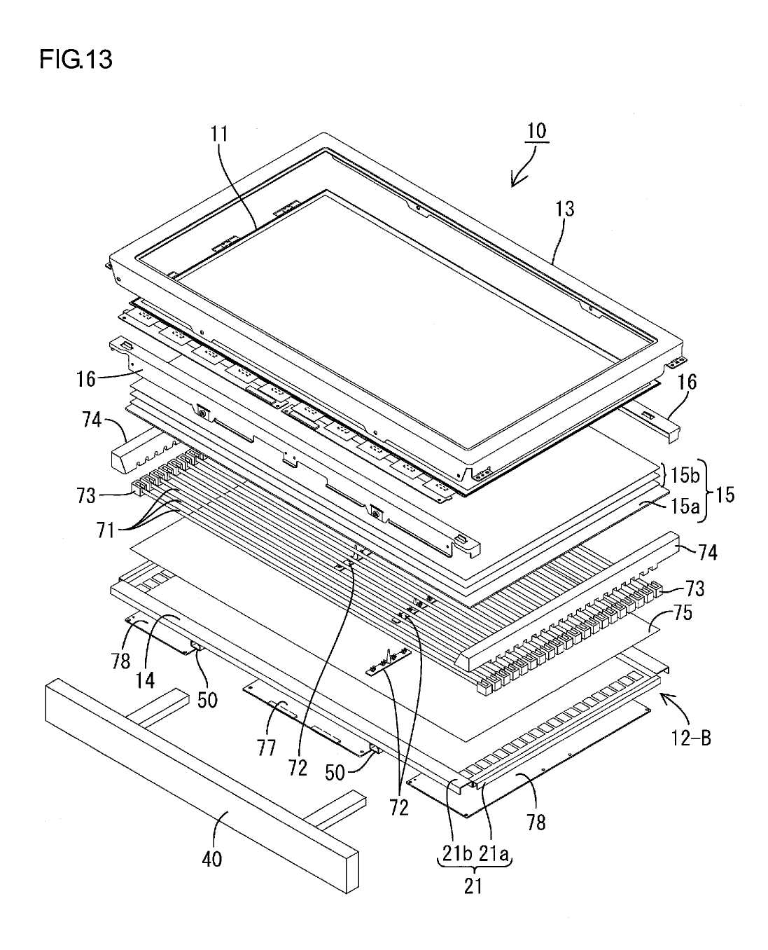

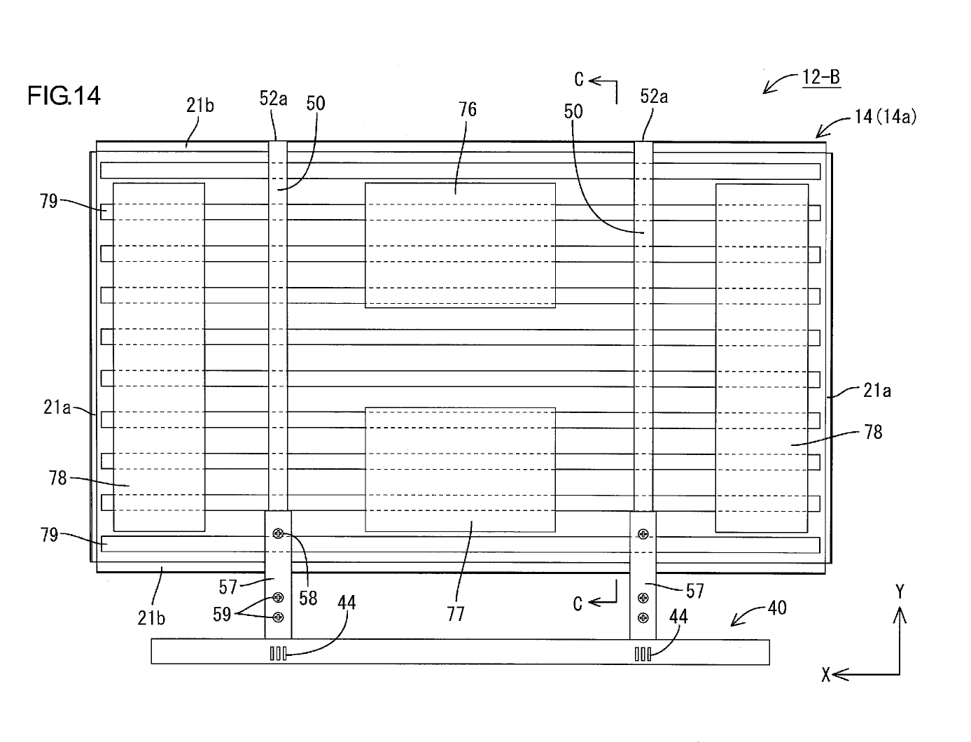

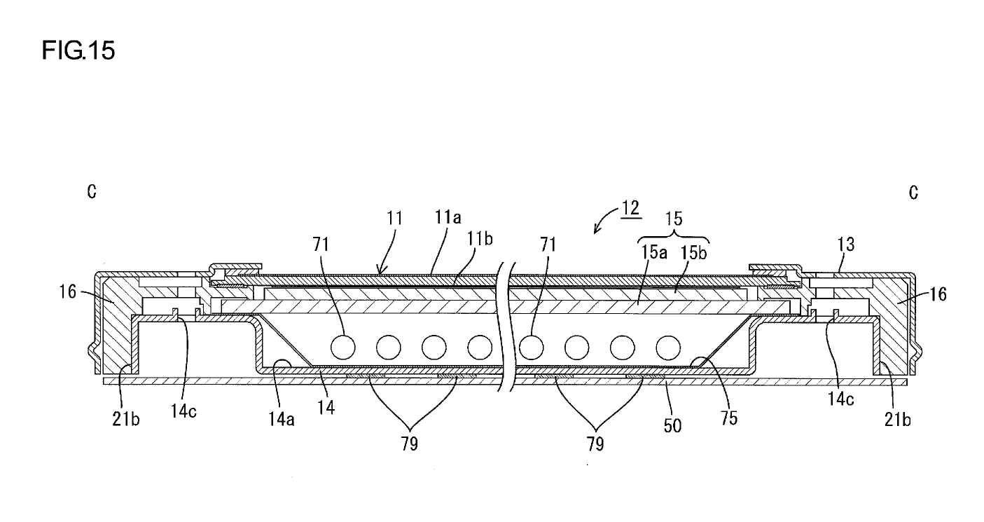

### BRIEF DESCRIPTION OF THE DRAWINGS

[FIG. 1] is an exploded perspective view illustrating a general construction of a television receiver according to a first embodiment of the present invention;

[FIG. 2] is an exploded perspective view illustrating a general construction of a liquid crystal display device provided in the television receiver in FIG. 1;

[FIG. 3] is a cross-sectional view of the liquid crystal display device in FIG. 2 along the short-side direction;

[FIG. 4] is a cross-sectional view of the liquid crystal display device in FIG. 2 along the long-side direction;

[FIG. 5] is a perspective view illustrating a general construction of an LED board provided in the liquid crystal display device in FIG. 2;

[FIG. 6] is a plan view illustrating a rear-side construction of a backlight device provided in the liquid crystal display device in FIG. 2;

[FIG. 7] is a perspective view illustrating a construction of a columnar member provided in the liquid crystal display device in FIG. 2;

[FIG. 8] is a cross-sectional view taken along an A-A line in FIG. 6;

[FIG. 9] is a perspective view illustrating a rear-side construction of a stand provided in the backlight device;

[FIG. 10] is an explanation view illustrating a construction of a connecting part of a chassis and the stand;

[FIG. 11] is a cross-sectional view taken along a B-B line in FIG. 10;

[FIG. 12] is an enlarged cross-sectional view illustrating a rear-side construction of a main part of the backlight device according to a second embodiment of the present invention;

[FIG. 13] is an exploded perspective view illustrating a general construction of a liquid crystal display device according to a third embodiment of the present invention;

[FIG. 14] is a plan view illustrating a back-side construction of the backlight device provided in the liquid crystal display device in FIG. 13; and

[FIG. 15] is a cross-sectional view taken along a C-C line in FIG. 14.

### BEST MODE FOR CARRYING OUT THE INVENTION

### First Embodiment

The first embodiment of the present invention will be explained with reference to FIGS. 1 to 11. A construction of a television receiver TV including a liquid crystal display device 10 will be explained.

FIG. 1 is an exploded perspective view illustrating a general construction of the television receiver of this embodiment. FIG. 2 is an exploded perspective view illustrating a general construction of the liquid crystal display device included in the television receiver in FIG. 1. FIG. 3 is a cross-sectional view of the liquid crystal display device in FIG. 2 along the short-side direction. FIG. 4 is a cross-sectional view of the liquid crystal display device in FIG. 2 along the long-side direction. FIG. 5 is a perspective view illustrating a general construction of an LED board included in the liquid crystal display device in FIG. 2.

As illustrated in FIG. 1, the television receiver TV of the present embodiment includes the liquid crystal display device 10, front and rear cabinets Ca, Cb that house the liquid crystal display device 10 therebetween, a power source P and a tuner T. An overall shape of the liquid crystal display device (display device) 10 is a landscape rectangular. The liquid crystal display device 10 is housed in a vertical position. As illustrated in FIG. 2, it includes a liquid crystal panel 11 as a display panel, and a backlight device 12 (lighting device), which is an external light source. They are integrally held by a bezel 13 and the like. The television receiver TV is supported at a predetermined height by a stand 40 included in the backlight device 12 so that a TV viewer watches a television screen horizontally.

Next, the liquid crystal panel 11 and the backlight device 12 included in the liquid crystal display device 10 will be explained (see FIGS. 2 to 4).

The liquid crystal panel (display panel) 11 is constructed such that a pair of glass substrates is bonded together with a predetermined gap therebetween and liquid crystal is sealed between the glass substrates. On one of the glass substrates, switching components (e.g., TFTs) connected to source lines and gate lines that are perpendicular to each other, pixel electrodes connected to the switching components, and an alignment film are provided. On the other substrate, counter electrodes, color filter having color sections such as R (red), G (green) and B (blue) color sections arranged in a predetermined pattern, and an alignment film are provided. Polarizing plates 11a, 11b are attached to outer surfaces of the substrates (see FIGS. 3 and 4).

As illustrated in FIG. 2, the backlight device 12 includes a chassis 14, an optical member 15, and frames 16. The chassis 14 has a substantially box-shape and an opening on the light output side (on the liquid crystal panel 11 side). The optical member 15 is provided to cover the opening of the chassis 14. The frames 16 arranged along the long sides of the chassis 14 holds the long-side edges of the optical member 15 to the chassis 14. The long-side edges of the optical member 15 are sandwiched between the chassis 14 and the frames 16. The stand S is provided in a middle part of one of the long side edges of the chassis 14 so as to vertically support the chassis 14 in a vertical position. LED boards 17, a light guide plate 18 and holders 20 are provided in the chassis 14. Each of the LED boards 17 is provided on each of the long side edges of the chassis 14 and emits light. The light guide plate 18 is provided between the LED boards 17 and guides light emitted from the LED boards 17 to the liquid crystal panel 11. The edges of the optical member 15 are placed on the holders 20. In the edge-light backlight device 12 of this embodiment, the light source is provided at the side of the chassis 14.

The chassis 14 is prepared by processing a metal plate. It is formed in a substantially shallow box shape. It includes a rectangular bottom plate 14a and outer rims 21 each of which extends upright from the corresponding side of the bottom plate 14a and has a substantially U shape. The outer rims 21 include short-side outer rims 21a and long-side outer rims 21b. Fixing holes 14c are formed in an upper surface of the long-side outer rims 21 of the chassis 14 as illustrated in FIG. 3. The bezel 13, the frames 16 and chassis 14 are integrally fixed by screws inserted in the fixing holes 14c. The chassis 14 is made of metal to ensure rigidity in this embodiment. However, the chassis 14 may be made of metal such as an aluminum material if greater heat conductivity is required.

On the opening side of the chassis 14, the optical member 15 including a diffuser plate 15a and optical sheets 15b is provided. The diffuser plate 15a includes a synthetic resin plate containing scattered light diffusing particles. It diffuses linear light emitted from the LED boards 17 and guided by the light guide plate 18. The short-side edge of the diffuser plate 15a is placed on the holder 20, and does not receive a vertical force (see FIG. 4). As illustrated in FIG. 3, the long-side edges of the diffuser plate 15a are sandwiched between the chassis 14 and the frame 16.

The optical sheets 15b provided on the diffuser plate 15a include a diffuser sheet, a lens sheet and a reflecting type polarizing plate layered in this order from the diffuser plate 15a side. Light emitted from the LED boards 17 passes through the diffuser plate 15a and enters the optical sheets 15b. The optical sheets 15b are provided for converting the light to planar light. The liquid crystal display panel 11 is disposed on the top surface of the top layer of the optical sheets 15b. The optical sheets 15b are held between the diffuser plate 15a and the liquid crystal panel 11.

The LED board 17 includes a base plate 31 and LED light sources (light sources) 33 as illustrated in FIG. 5. The base plate 31 is formed of a resin plate. The LED light sources 33 are provided along a line and each of them has three LED chips 32 each of which emits light of single color of R (red), G (green) and B (blue). The LED chips 32 are fixed by resin. Each of the LED boards 17, 17 is fixed to the corresponding long-side outer rim 21b of the chassis 14 by a screw, for example, so that the LED light sources 33 are opposed to each other.

The light guide plate 18 is formed in a rectangular plate and formed of resin having high translucency (high transparency) such as acrylic. The light guide plate 18 is disposed between the opposing LED boards 17 so that its main surface faces the diffuser plate 15a as illustrated in FIG. 3. A light reflecting sheet 19 is disposed on a surface of the light guide plate 18 opposite from the surface facing the diffuser plate 15a. The light reflecting sheet 19 reflects the light penetrating through the light guide plate 18 and returns the light into the light guide plate 18. The light guide plate 18 makes the light emitting from the LED boards 17 and entering the side surfaces of the light guide plate 18 to be output from the main surface of the light guide plate 18 facing the diffuser plate 15a. Accordingly, the light is irradiated to the liquid crystal panel 11 from its rear side.

Next, a rear-side configuration of the backlight device 12 (a surface of the chassis 14 opposite from the surface having the LED light sources 33) will be explained in detail with reference to FIGS. 6 to 11.

FIG. 6 is a plan view illustrating a rear-side construction of the backlight device provided in the liquid crystal display device. FIG. 7 is a perspective view illustrating a construction of the columnar member provided in the liquid crystal display device. FIG. 8 is a cross-sectional view taken along an A-A line in FIG. 8. FIG. 9 is a perspective view illustrating a back-side construction of the stand provided in the backlight device. FIG. 10 is an explanation view illustrating a construction of a connecting part of the chassis and the stand. FIG. 11 is a cross-sectional view taken along a B-B line in FIG. 10. In the drawings, an X-axis direction represents a horizontal direction and a Y-axis direction represents a vertical direction.

The backlight device 12 is supported in a vertical position by the stand 40 so that a plate surface of the bottom plate 14a of the chassis 14 lie along the vertical direction (Y-axis direction in FIG. 6). In this embodiment, the chassis 14 is supported so that the short-side outer rims 21a lie along the vertical direction (Y-axis direction or a vertical direction) and the long-side outer rims 21b lie along the X-axis direction or a lateral direction in FIG. 6). The chassis 14 is positioned to be horizontally long so that the long-side outer rims 21b are positioned at upper and lower sides and the short-side outer rims 21a are positioned at left and right sides. The stand 40 is provided on the lower long-side outer rim 21b.

A power source circuit board 22 that generates electric power for driving the LED boards 17 and a control circuit board 23 that controls driving of the LED boards 17 are arranged in a middle portion of the bottom plate 14a of the chassis 14. A belt-like copper thin film (heat conductive part) 24 is provided along a long-side direction of the bottom plate 14a so as to be overlapped with each of the two LED boards 17 that are provided at upper and lower ends of the bottom plate 14a. In other words, the copper thin film 24 extends along the arrangement line of the LED light sources 33 that are provided in a line.

Two columnar members 50, 50 are provided to sandwich the electric power circuit board 22 and the control circuit board 23. Each one of the columnar members 50 is provided between the electric power circuit board 22 or the control circuit board 23 and each short-side outer rim 21a. Specifically, the columnar members 50, 50 are provided with a predetermined distance therebetween so that their longitudinal direction aligns along the short-side direction of the chassis 14. The columnar members 50 provided on the bottom plate 14a of the chassis 14 improve strength of the chassis 14 and maintain a shape of the chassis 14. That is, the chassis 14 is prevented from being deformed.

Each columnar member 50 is formed by bending a metal plate and it includes a rectangular upper plate 51a, side plates 52b, 51c, and lower plates 51d, 51e as illustrated in FIG. 7. The side plates 51b, 51c are formed by bending the metal plate at each of the long-side end portions of the upper plate 51a substantially vertically. The lower plates 51d, 51e are formed by bending the metal plate at each long-side end portion of the side plates 51b, 51c. The lower plates 51d, 51e are spaced from each other. Surfaces of the lower plates 51d, 51e (surfaces facing the chassis 14) lie on the same plane. The columnar member 50 is formed in a hollow member that is surrounded by the upper plate 51a and the side plates 51b, 51c. The columnar member 50 has a first opening 52a and a second opening 52b at its two longitudinal ends so that the hollow part communicates with outside. The longitudinal length of the columnar member 50 is substantially equal to the short-side length of the chassis 14.

An attachment example of the columnar member 50 will be explained with reference to FIG. 8. Metal connecting parts 53 are fixed by screws to the positions on the chassis 14 where the columnar members 50 are supposed to be attached. The connecting part 53 is formed in a longitudinal member so that its longitudinal direction aligns along the short-side direction of the chassis 14. The connecting part 53 is provided on the chassis 14 so as to come in contact with the copper thin film 24 on the portion where the copper thin film 24 is provided (especially in this embodiment, the connecting part 53 is placed on the copper thin film 24). The connecting part 53 includes a main body 54 and connection parts 55a, 55b. The main body 54 has an opening at a side opposite from the chassis 14. The connection parts 55a, 55b are formed by bending the metal plate at the end of the main body 54 substantially vertically to the side opposite from the opening (outwardly). The connecting part 53 further includes heat releasing fins 56 that extend from the chassis 14 side of the main body 54 outwardly. A material of the connecting part 53 is not limited but preferably has heat conductivity of the chassis 14 or greater with consideration for the heat releasing effects. Further, the heat releasing fins 56 may be formed integrally with the connecting part 53 or may be prepared independently and attached to the connecting part 53.

The columnar member 50 is connected to the connecting part 53 by sliding along the short-side direction of the chassis 14. Specifically, the connecting parts 55a, 55b of the connecting part 53 are inserted in the first opening 52a of the columnar member 50. Then, the connecting parts 55a, 55b and the lower plates 51d, 51e are engaged with each other by sliding the columnar member 50 along the longitudinal direction. This connects the columnar member 50 and the connecting part 53 and the attachment of the columnar member 50 to the chassis 14 is completed.

To improve the effect of heat releasing from the chassis 14, it is preferable to provide a resin member TS having excellent heat conductivity between the connecting part 53 and the chassis 14. As examples of the resin member TS, it is preferable to select one from a silicone sheet, a compound containing metal powder, a rubber packing with its surface covered with mesh metal and others.

Thus, since the columnar members 50 are attached to the chassis 14, heat generated from the LED boards 17 are dispersed via the chassis 14 and the copper thin film 24 and further released via the connecting part 53 to a heat carrier (air) existing in the hollow part of each columnar member 50. The heat releasing fins 56 are provided in this embodiment to improve heat releasing ability from the chassis 14. However, the heat releasing fins may not be provided if a relatively small heat releasing ability is required.

The stand 40 includes a base seat 41 and two support parts 42, 42 that are fitted into the base seat 41 and extend vertically therefrom. The support part 42 is a hollow member having an outer appearance of a quadrangular prism. An opening 43 is formed at an end (opposite from the base seat 41 side) of each support part 42 so as to communicate the hollow part with outside. Openings 44 are formed at the rear side (a side of the base seat 41 opposite from the light output side of the backlight device 12) of the base seat 41 so as to communicate the hollow part of the support part 42 with outside.

Each support part 42 is connected to each columnar member 50 so that the stand 40 supports the columnar members 50 vertically (in a vertical position). More specifically, as illustrated in FIGS. 10 and 11, the column 50 and the support part 42 are positioned so that the second opening 52b of the columnar member 50 corresponds to the opening 43 of the support part 42. A cover 57 is provided to cover the lower end of the columnar member 50 and the support part 42. The cover 57 is fixed to the columnar member 50 and the chassis 14 by a screw 58 and fixed to the support part 42 by two screws 59, 59. The columnar member 50 is thus connected to the stand 40 via the cover 57, and therefore, the chassis 14 is supported by the stand 40.

Since the columnar member 50 is connected to the stand 40 as described above, a continuous space is formed through the opening 44 and the opening 43 of the stand 40 and the second opening 52b and the first opening 52a of the columnar member 50. Therefore, convection of a heat carrier (air)) in the hollow part of the columnar member 50 is caused in the continuous space. Further, the space is communicated with outside via the first opening 52a of the columnar member 50 and the opening 44 of the stand 40. Therefore, according to the convection of the heat carrier, heat generated from the LED light sources 33 is released to outside. To improve the heat releasing ability, a mechanism for blowing air of normal temperature or lower from the opening 44 may be provided to increase the heat amount releasing from the first opening 52a of the columnar member 50.

As explained above, according to the present embodiment, the backlight device 12 includes the columnar members 50 provided at the rear side of the chassis 14 and the copper thin film 24 provided so as to overlap with the LED light sources 33. Each columnar member 50 is formed to be a hollow member and has the first opening 52a and the second opening 52b that communicate the inside with the outside of the hollow member. Also, the copper thin film 24 is provided so as to extend from the part of the bottom plate 14a of the chassis 14 that overlaps with the LED light source 33 to the part of the bottom plate 14a that overlaps with the columnar member 50.

Thus, since the copper thin film 24 is provided on the part of the chassis 14 that overlaps with the LED light source 33, heat generated by the LED power source 33 is transferred to and dispersed by the copper thin film 24. This prevents the temperature in the vicinity of the LED light source 33 from rising. Further, since the copper thin film 24 is provided so as to extend from the part of the bottom plate 14a that overlaps with the LED light source 33 to the part of the bottom plate 14a that overlaps with the columnar member 50, the heat dispersed by the copper thin film 24 is transferred to the columnar member 50. The columnar member 50 is formed in the hollow member and has the openings 52a, 52b that communicate the inside with the outside of the hollow member. Therefore, convection of a heat carrier (air) is caused in the hollow part of the columnar member 50 and heat is released from the openings 52a, 52b to outside. As a result, the heat generated by the LED light sources 33 is preferably released via the copper thin films 24 and the columnar members 50. This suppresses the temperature of the backlight device 12 from rising and a uniform temperature distribution is ensured.

The backlight device 12 of the present embodiment includes the stand 40 that vertically supports the columnar members 50. The stand 40 has the openings 44 that communicate the hollow part of the columnar member 50 with the outside of the stand 40 with supporting the columnar members 50.

With this configuration, a continuous space (communication path) is formed from the openings 44 of the stand 40 to the first openings 52a of the columnar members 50. This releases the heat kept in the hollow parts of the columnar members 50 to the outside via the openings 44 and the first openings 52a of the columnar members 50.

Especially in the present embodiment, the openings 44 are formed on the side of the backlight device 12 opposite from the light output side, that is, the rear side of the backlight device 12. Therefore, the openings 44 are less likely to be recognized by a user and the backlight device 12 has a good design.

In the present embodiment, the LED light sources 33 are arranged in a line and the copper thin film 24 extends along the arrangement line of the LED light sources 33. This configuration efficiently disperses the heat generated by the LED light sources 33 and further effectively suppresses the generation of high temperature parts.

In the present embodiment, the heat releasing fins 56 are provided in the part of the chassis 14 covered by each columnar member 50. Therefore, the heat generated by the LED light sources 33 is efficiently released to the hollow part of each columnar member 50 by the heat releasing fins 56.

The edge-light backlight device 12 in which the LED light sources 33 are arranged at the periphery of the chassis 14 is used in the present embodiment.

In the edge-light backlight device 12, the surrounding space of the LED light sources 33 is small and closed. This makes difficult to release the heat generated by the LED light sources 33 to the outside of the device and also makes easy to increase the temperature of the part in which the LED light sources 33 are arranged. However, the backlight device 12 of the present embodiment is configured to have the copper thin films 24 and the columnar members 50 to preferably release the heat. This suppresses the temperature of the specific parts from rising and a uniform temperature distribution of the backlight device 12 is ensured.

### Second Embodiment

A second embodiment of the present invention will be explained with reference to FIG. 12. The configuration of the columnar member is changed from the first embodiment, and other configurations are same as the first embodiment. The same parts as the first embodiment are indicated by the same symbols and will not be explained.

FIG. 12 is an enlarged cross sectional view illustrating a rear-side configuration of a main part of the backlight device according to the second embodiment.

A columnar member 60 provided in a backlight device 12-A includes a rectangular upper plate 61a, side plates 61b, 61c and lower plates 61d, 61e. The side plates 61b, 61c are formed by bending a metal plate at the long-side ends of the upper plate 61a substantially vertically. The lower plates 61d, 61e are formed by bending the metal plate at the long side ends of the side plates 61b, 61c at a substantially right angle outwardly. The lower plates 61d and 61e are spaced from each other and the columnar member 60 is formed in a hollow member that is surrounded by the upper plate 61a and the side plates 61b, 61c. The columnar member 60 has openings at two longitudinal ends so as to communicate the hollow part with outside.

Heat releasing fins 62 are provided on an inner surface of the upper plate 61a of the columnar member 60 so as to extend toward the chassis 14 (toward the hollow part). The heat releasing fins 62 may be integrally formed with the columnar member 60 or may be prepared separately and attached to the columnar member 60. In this embodiment, the heat releasing fins 62 are provided to improve the heat releasing ability from the chassis 14. However, the heat releasing fins are not required if relatively small heat releasing ability is required.

The columnar member 60 is fixed to the rear side (a side of the bottom plate 14a opposite from the side on which the LED boards 17 are arranged) of the bottom plate 14a of the chassis 14 by screws 63 penetrating through the lower plates 61d, 61e respectively. The columnar member 60 is arranged so that its longitudinal direction aligns along the short-side direction of the chassis 14. On the part of the chassis 14 on which the copper thin film 24 is provided, the columnar member 60 is provided to come in contact with the copper thin film 24 (especially in the second embodiment, the columnar member 60 is placed on the copper thin film 24).

With the above-explained configuration, heat generated by the LED light sources 33 is transferred to the columnar member 60 via the copper thin film 24. The columnar member 60 is formed in the hollow member and has the openings that communicate the inside with the outside of the hollow member. Therefore, convection of a heat carrier (air) is caused in the hollow part of the columnar member 60 and the heat is released from the openings to outside.

As a result, preferable heat releasing effects are obtained. This suppresses the temperature from rising in the vicinity of the LED light sources 33 in the backlight device 12-A and a uniform temperature distribution is ensured.

### Third Embodiment

A third embodiment of the present invention will be explained with reference to FIGS. 13 to 15. The third embodiment differs from the first and second embodiments in that a direct-type backlight device in which a plurality of cold cathode tubes are arranged is used, and other configurations are same as the above embodiments. The same parts as the above embodiments are indicated by the same symbols and will not be explained.

FIG. 13 is an exploded perspective view illustrating a general construction of a liquid crystal display device according to the third embodiment. FIG. 14 is a plan view illustrating a back-side construction of the backlight device provided in the liquid crystal display device in FIG. 13. FIG. 15 is a cross-sectional view taken along a C-C line in FIG. 14.

A backlight device 12-B is a direct-light type backlight device in which light sources are arranged closely below the rear side of the liquid crystal panel 11 as illustrated in FIG. 13. The backlight device 120B includes cold cathode tubes (light sources) 71 that are linear light sources, lamp clips 72, lamp holders 73 and holders 74 in the chassis 14. The lamp clip 72 holds the cold cathode tubes 71 to be fixed to the chassis 14. The lamp holder 73 holds each end of the cold cathode tube 71. The holder 74 collectively covers the ends of the cold cathode tubes 71 and the lamp holders 73.

A reflective sheet 75 is provided on an inner side (a side of the bottom plate 14a facing the cold cathode tubes 71) of the bottom plate 14a of the chassis 14. The reflective sheet 75 is made of synthetic resin and has a surface in white color that provides high light reflectivity. It is placed so as to cover almost entire inner surface of the bottom plate 14a of the chassis 14. At the opening side of the chassis 14, the optical member 15 including the diffuser plate 15a and the optical sheet 15b is disposed. In the backlight device 12-B, a side close to the diffuser plate 15a from the cold cathode tubes 71 is referred to as a light output side.

Each cold cathode tube 71 has an elongated tubular shape. A plurality of the cold cathode tubes 71 are installed in the chassis 14 such that they are arranged parallel to each other with the long-side direction thereof aligned along the long-side direction of the chassis 14. The cold cathode tubes 71 are arranged over an entire area of the bottom plate 14a of the chassis 14. Each cold cathode tube 71 is held by the corresponding lamp clip 72 to be spaced from the bottom plate 14a (reflective sheet 75) of the chassis 14 with a small gap therebetween. Each end of the cold cathode tube 71 is fitted in the lamp holder 73 and the holder 74 is provided to cover the lamp holders 73.

The rear-side (a side of the chassis 14 opposite from the side on which the cold cathode tubes 71 are arranged) construction of the backlight device 12 will be explained. As illustrated in FIG. 14, a power source circuit board 76 that generates electric power for driving the cold cathode tubes 71 and a control circuit board 77 that controls driving of the cold cathode tubes 71 are arranged in the middle portion of the bottom plate 14a of the chassis 14. An inverter board 78 is arranged at each end of the bottom plate 14a close to the short side. The inverter board 78 drives each cold cathode tube 71 based on electric power output from the power source circuit board 76 and control signals output from the control circuit board 77.

A plurality of belt-like copper thin films 79 are provided on the bottom plate 14a of the chassis 14 along its long-side direction. More specifically, the copper thin film 79 is provided on the bottom plate 14a so as to overlap with the cold cathode tube 71. Especially, each copper thin film 79 is provided to overlap with the adjacent cold cathode tubes 71 as illustrated in FIG. 15. Each copper thin film 79 extends along an axial line of the cold cathode tube 71.

The columnar member 50 extends along the short-side direction of the chassis 14 between each inverter board 78 and the power source circuit board 76 or the control circuit board 77 on the bottom plate 14a of the chassis 14. The columnar member 50 is provided in the part of the chassis 14 on which the copper thin film 79 is provided so as to come in contact with the copper thin film 79 (especially in this embodiment, the columnar member 50 is placed on the copper thin film 79).

As explained above, the direct-light type backlight device 12-B in which the cold cathode tubes 71 that are linear light sources are arranged is used in this embodiment. The copper thin film 79 is provided on the bottom plate 14a of the chassis 14 so as to overlap with the adjacent cold cathode tubes 71, 71.

With this configuration, the heat generated from the cold cathode tubes 71 is transferred to the copper thin films 79 and dispersed in the copper thin films 79. This suppresses the temperature in the vicinity of the cold cathode tubes 71 from rising. Since the copper thin films 79 come in contact with the columnar members 50, the heat generated from the cold cathode tubes 71 is released to outside via the copper thin films 79 and the hollow parts of the columnar members 50. This suppresses the temperature of the backlight device 12-B from rising and a uniform temperature distribution is ensured.

In this embodiment, the copper thin film 79 extends along the axial line of the cold cathode tubes 71. Therefore, the heat generated from the cold cathode tubes 71 is efficiently dispersed and this further effectively suppresses the generation of the parts of high temperature.

### Other Modifications

The embodiments of the present invention have been described, however, the present invention is not limited to the above embodiments explained in the above description and the drawings. The following embodiments may be included in the technical scope of the present invention, for example.

(1) In the above embodiments, the belt-like copper thin film is provided as the heat conductive part that transfers heat generated from the light source. However, a material having relatively great heat conductivity such as a metal may be used for the heat conductive part and a shape of the heat conductive part may be any shape such as a linear shape or a columnar shape.

(2) In the above embodiments, the columnar member is made of metal. However, the material of the columnar member is not limited thereto. With consideration for the heat releasing effect of the backlight device, the material having heat conductivity of the chassis or greater is preferable.

(3) In the first and second embodiments, the LED light source is obtained by fixing by resin three LED chips each of which emits single color light of R (red), G (green) and B (blue) respectively. However, the LED light source that emits white light and in which three chips of, for example, R, G, B are mounted by surface mounting may be used. Also, the colors of light generated by the chips are not limited to R, G and B, and other colors of light may be used.

(4) In the above embodiments, the LED light source or the cold cathode tube is used as the light source. However, other kinds of light sources such as a hot cathode tube may be used as the light source.

1. A lighting device comprising:
at least one light source;
a chassis housing the light source;
a heat conductive part that transfers heat generated from the light source; and
a columnar member that keeps a shape of the chassis, wherein:
the columnar member is configured by a hollow member that is provided on a side of the chassis opposite from a side facing the light source, and the hollow member has an opening that communicates inside with outside of the hollow member; and
the heat conductive part is provided on a part of the chassis that overlaps with the light source and extends from the part overlapping with the light source to a part of the chassis that overlaps with the columnar member.

2. The lighting device according to claim 1, further comprising:
a stand that is configured to support the columnar member in a vertical position, the stand having a stand opening that communicates an inner hollow space of the columnar member with outside with supporting the columnar member.

3. The lighting device according to claim 2, wherein the stand opening is provided on a side of the stand opposite from a light output side of the lighting device.

4. The lighting device according to claim 1, wherein the light source includes a plurality of light sources and the heat conductive part extends along an arrangement line of the light sources.

5. The lighting device according to claim 1, wherein the light source is formed in a linear shape, and the heat conductive part extends along an axial line of the light source.

6. The lighting device according to claim 1, further comprising a heat releasing member provided in a part of the chassis that is covered by the columnar member.

7. The lighting device according to claim 1, being an edge-light lighting device in which the light source is provided on a peripheral part of the chassis.

8. A display device comprising:
the lighting device according to claim 1; and
a display panel configured to provide display using light from the lighting device for a display device.

9. The display device according to claim 8, wherein the display panel is a liquid crystal display panel using liquid crystal.

10. A television receiver comprising the display device according to claim 8.
